(19) United States
(12) Patent Application Publication
(10) Pub. No.: US 2008/0291257 A1
(43) Pub. Date: Nov. 27, 2008

(54) INK JET RECORDING MATERIAL AND METHOD FOR MANUFACTURING THE SAME

(75) Inventor: Yasuhiro OGATA, Fujinomiya-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 12/024,615

(22) Filed: Feb. 1, 2008

(30) Foreign Application Priority Data
Mar. 14, 2007 (JP) 2007-064800

(51) Int. Cl. B41J 3/407

(52) U.S. Cl. 347/106

(57) ABSTRACT

The present invention provides an ink jet recording material and a method for manufacturing the same, wherein the ink jet recording material comprises: a support having a base paper and polyolefin resin layers covering the both sides of the base paper; an ink receiving layer formed on one side of the support; and a back layer containing a polyurethane resin formed on the other side of the support opposite to the side having the ink receiving layer, wherein the back layer is formed within three hours after the polyolefin resin layer is formed on the other side of the base paper.

### CROSS-REFERENCE TO RELATED APPLICATION

This application claims priority under 35USC 119 from Japanese Patent Application No. 2007-064800, the disclosure of which is incorporated by reference herein.

### BACKGROUND OF THE INVENTION

1. Field of the Invention

The present invention relates to an ink jet recording material and a method for manufacturing the same.

2. Description of the Related Art

In response to the recent rapid development of the information industry, various information processing systems have been developed, such as ink jet recording methods, thermal recording methods, pressure sensitive recording methods, photosensitive recording methods, and transfer recording methods. In addition, recording methods and apparatuses suitable for information processing systems have been also developed and brought into practical use. Among these various recording methods, ink jet recording methods are increasingly used for home uses as well as business uses, because the methods are useful for recording on various kinds of recording materials, and the equipment required is relatively inexpensive, compact, and very quiet.

In addition, the recent increase in the resolution of ink jet printers has brought about recording of high image quality with photographic quality. With the development of the hardware (equipment), various ink jet recording sheets have been developed. In general, ink jet recording media are required to have: (1) quick-drying properties for quickly absorbing inks; (2) ink dots having an adequate and uniform diameter with no bleeding; (3) good graininess;(4) ink dots having a high circularity; (5) high color densities; (6) high color saturation with no color restraint; (7) good water resistance, light fastness, and ozone resistance in printed areas; (8) high whiteness of recording sheets; (9) good storability of recording sheets (to prevent yellowing or image bleeding during long-term storage (good anti-bleeding properties over time)); (10) resistance to deformation and good dimensional stability (negligible curling); and (11) good runnability in hardware.

Photographic glossy paper used for high image quality recording having photographic quality requires, in addition to the above properties, glossiness, glossiness in printed image areas, surface smoothness, and paper texture similar to a silver salt photographic print paper.

In order to improve the above properties required for ink jet recording materials, in recent years, ink jet recording materials having a porous ink receiving layer have been developed and brought into practical use. Such ink jet recording materials have a porous structure so as to have excellent ink receiving properties (quick-drying properties) and high glossiness.

Ink jet recording materials are stored in the form of a roll wherein an ink receiving layer is in contact with the side opposite to the side having the ink receiving layer, which may cause various defects. Some inventions for improving transportability of an ink jet recording material have been disclosed, wherein a specific back layer is provided on a side opposite to the side having an ink receiving layer, to prevent adhesion between the ink receiving layer and the side opposite to the side having the ink receiving layer during storage in roll form (for example, see Japanese Patent Application Laid-Open (JP-A) No. 2003-80834). According to other inventions, a back layer containing a polyurethane resin is provided on a side opposite to the side having an ink receiving layer, so that the ink receiving layer is protected from transport-induced damage and the transportation accuracy of the ink jet recording material is improved (for example, see JP-A No. 2005-205765).

### SUMMARY OF THE INVENTION

The present invention has been made in view of the above circumstance and provides an ink jet recording material and a method for manufacturing the same.

A first aspect of the present invention provides an ink jet recording material comprising: a support having a base paper and polyolefin resin layers covering the both sides of the base paper; an ink receiving layer formed on one side of the support; and a back layer containing a polyurethane resin formed on the other side of the support opposite to the side having the ink receiving layer, wherein the back layer is formed within three hours after the polyolefin resin layer is formed on the other side of the base paper.

A second aspect of the present invention provides a method for manufacturing an ink jet recording material, where a support having a base paper and polyolefin resin layers covering the both sides of the base paper; an ink receiving layer formed on one side of the support; and a back layer containing a polyurethane resin formed on the other side of the support opposite to the side having the ink receiving layer, are formed, wherein the back layer is formed within three hours after the polyolefin resin layer is formed on the other side of the base paper.

### BRIEF DESCRIPTION OF THE DRAWINGS

Exemplary embodiments of the present invention will be described in detail based on the following figures, wherein:

FIG. 1 is an explanatory drawing showing a manufacturing line for manufacturing a support and forming a back layer and a subbing layer in succession;

FIGS. 2A and 2B are explanatory drawings showing manufacturing lines for making a support and forming a back layer and a subbing layer separately.

### DETAILED DESCRIPTION OF THE INVENTION

The ink jet recording material and the method for manufacturing the same in accordance with the invention are described below in detail. The ink jet recording material of the invention comprises: a support having a base paper and polyolefin resin layers covering the both sides of the base paper; an ink receiving layer formed on one side of the support (hereinafter sometimes referred to as the first side); and a back layer containing a polyurethane resin formed on the other side of the support opposite to the side having the ink receiving layer (hereinafter sometimes referred to as the second side), wherein the back layer is formed within three hours after the polyolefin resin layer is formed on the other side of the base paper. The method of the invention for making an ink jet recording material includes forming the back layer within three hours after the polyolefin resin layer is formed on the other side of the base paper.

When the ink jet recording material has the above-described structure, the ink jet recording material provides excellent image clarity and runnability in a printer, and the back layer thereof has favorable adhesion characteristics and favorable blocking properties under high humidity. The method of the invention for manufacturing an ink jet recording material provides the ink jet recording material of the invention which provides excellent image clarity and runnability in a printer, and the back layer thereof has favorable contact characteristics and favorable blocking properties under high humidity. The components of the ink jet recording material and the method for manufacturing the same in accordance with the invention are further described below.

(Support)

The support used in the invention has a base paper and polyolefin resin layers covering the both sides of the base paper. The base paper used for the support preferably has a basis weight of from about 190 to about 230 g/m² to improve the texture of the ink jet recording material. The base paper comprises one or more kinds of pulp such as natural pulp, recycled pulp, and synthetic pulp. The base paper is preferably a smooth base paper such as a resin-coated paper support for photographic printing. The base paper contains appropriate additives used for common papermaking, such as a sizing agent, a paper strengthening agent, a filler, an anti-static agent, an anchoring agent, and a dye. The surface of the base paper is preferably smoothed by compression through calendering or the like during or after papermaking.

The ink jet recording material of the invention has an ink receiving layer on the first side of the support, and the polyolefin resin layer on the first side may contain a white pigment and an optical brightener to improve whiteness on the first side. The surface of the polyolefin resin layer on the first side preferably has a whiteness of about 95% or more, more preferably about 97% or more. The whiteness may be measured in accordance with ISO-2470 using, for example, WMS-1 manufactured by Murakami Color Research Laboratory Co., Ltd. The type and addition amount of the white pigment and the optical brightener are preferably controlled so as to achieve the above-described whiteness.

The optical brightener contained in the polyolefin resin layer in accordance with the invention may be a commonly known one. Examples of the optical brightener include thiadiazole-based, oxadiazole-based, naphthalimido-based, imidazole-based, benzimidazole-based, thiazole-based, oxazole-based, triazole-based, diamino stilbene-based, bis(benzoxazolyl)naphthalene-based, bis(oxazolyl)thiophene-based, pyrazoline-based, pyrene-based, bis(benzoxazolyl)stilbene-based, dimethyl stilbene-based, and imidazolone-based brighteners. The optical brightener is melt-extruded together with a polyolefin resin at a high temperature. Therefore, the optical brightener is preferably resistant to high temperatures, and is not apt to cause bleeding over time. Preferable examples of such optical brighteners are bis(benzoxazolyl)naphthalene-based and bis(benzoxazolyl)stilbene-based optical brighteners. Specific examples of the optical brightener are listed below.

For example, 4,4′-bis(6-phenyl-benzoxazole-2-yl)stilbene, 4,4′-bis(5,6-dimethyl-benzoxazole-2-yl)stilbene, 4,4′-bis(benzoxazole-2-yl)stilbene, 4,4′-bis(6-methyl-benzoxazole-2-yl)stilbene, 4,4′-bis(6-ethyl-benzoxazole-2-yl)stilbene, 1,4′-bis(6-ethyl-benzoxazole-2-yl)naphthalene, 4,4′-bis(6-t-butyl-benzoxazole-2-yl)stilbene, 1,4′-bis(5,6-diethyl-benzoxazole-2-yl)naphthalene, 4,4′-bis(6-methoxy-benzoxazole-2-yl)stilbene, 4,4′-bis(5,6-diethyl-benzoxazole-2-yl)stilbene, 1,4′-bis(benzoxazole-2-yl)naphthalene, 1,4′-bis(6-methyl-benzoxazole-2-yl)naphthalene, 1,4′-bis(5,6-dimethyl-benzoxazole-2-yl)naphthalene, and 1,4′-bis(6-phenyl-benzoxazole-2-yl)naphthalene.

The content of the optical brightener in the polyolefin resin layer is preferably from 0.02 to 0.10% by mass, more preferably from about 0.04 to about 0.08% by mass relative to the polyolefin resin.

In the invention, the white pigment contained in the polyolefin resin layer is preferably titanium oxide for whiteness and dispersibility. The titanium oxide may be in rutile or anatase form, and these two forms may be used alone or in combination.

The average particle diameter of the white pigment used in the invention is preferably from about 0.1 to about 0.5 μm for whiteness and glossiness. The content of the white pigment in the polyolefin resin layer is preferably from about 5 to about 20% by mass with respective to the polyolefin resin.

The polyolefin resin layer in the support used in the invention preferably contains, in addition to the optical brightener and white pigment, an appropriate combination of various additives such as a blue pigment or dye such as cobalt blue, ultramarine blue, sicilian blue, or phthalocyanine blue, a magenta pigment or dye such as cobalt violet, fast violet, or manganese violet, an ultraviolet absorber, and an antioxidant.

The polyolefin resin used in the polyolefin resin layer is a homopolymer of an olefin such as low-density polyethylene, high-density polyethylene, polypropylene, polybutene, and polypentene; a copolymer composed of two or more olefins such as an ethylene-propylene copolymer; or a mixture of these polymers. These polymers having different densities and melting viscosity indexes (melt indexes) may be used alone or in combination. Among them, a polyethylene resin is particularly preferable.

In the invention, the polyolefin resin layer on the first side preferably contains a low-density polyethylene resin having a density of about 0.930/m³ or less at a ratio of about 90% by mass or more, more preferably 100% by mass with respect to the total resin. The polyolefin resin layer on the second side preferably contains a high-density polyethylene resin having a density of about 0.950 g/m³ or more at a ratio of about 30% by mass or more, more preferably about 50% by mass or more with respect to the total resin, and the upper limit thereof is about 95% by mass.

In the support used in the invention, the solid coating weight of the polyolefin resin layer on the first side is preferably from about 20 g/m² to about 45 g/m², more preferably from about 25 g/m² to about 40 g/m². The solid coating weight of the polyolefin resin layer on the second side is preferably from about 20 g/m² to about 40 g/m², more preferably from about 25 g/m² to about 35 g/m².

In the ink jet recording material of the invention, the support preferably has a subbing layer on the first side. The subbing layer is previously applied to and dried on the surface of the polyolefin resin layer before the ink receiving layer is formed, and comprises mainly a water-soluble polymer or a polymer latex which can be formed into a film. The polymer is preferably a water-soluble polymer such as gelatin, polyvinyl alcohol, polyvinylpyrrolidone, or water-soluble cellulose, and is particularly preferably gelatin. The subbing layer preferably further contains a surfactant and a hardener.

(Back Layer)

In the ink jet recording material of the invention, a back layer containing a polyurethane resin is formed on the second side of the support. The content of the polyurethane resin in the back layer is preferably about 50% by mass or more, more preferably about 70% by mass or more, and even more preferably about 80% by mass or more with respect to the total solid content in the back layer. The back layer containing a polyurethane resin improves transportation accuracy in a printer.

In the invention, the coating weight of the back layer is preferably from about 0.8 g/m² to about 1.5 g/m², more preferably from about 1 g/m² to about 1.3 g/m² in terms of the solid content of the polyurethane resin. If the coating weight of the back layer is less than about 0.8 g/m², sheet transportation accuracy in a printer is not ensured, and if more than about 1.5 g/m², curl balance may not be maintained in low-humidity and high-humidity environments.

The glass transition temperature (Tg) of the polyurethane resin contained in the back layer is preferably from about 35 to about 100° C., more preferably from about 40 to about 80° C. If the Tg is lower than about 35° C., sheet transportability in a printer decreases, and if higher than about 100° C., sheet transportation accuracy in a printer is lowered. High transportability in a printer refers to the absence of faults such as double feeding or feeding failure of sheets of an ink jet recording material. The transportation accuracy in a printer refers to accurate transportation according to the head speed of the printer. If the transportation accuracy decreases, faults such as banding or dislocation of the end position of printing on the ink jet recording material may occur.

Examples of the polyurethane resin used in the invention include aqueous polyurethane resins such as VONDIC series manufactured by Dainippon Ink And ChemicalsIncorporated, and aqueous polyurethane resins (urethane ionomers) such as HYDRAN series manufactured by Dainippon Ink And Chemicals, Incorporated. These resins may be used alone or in combination of two or more of them.

The back layer of the invention may further contain other additives such as an antioxidant, a surfactant, a pH adjusting agent, an anti-static agent, a curing agent, a coloring agent, and a preservative. The back layer preferably contains no pigment particles, to prevent transport-induced damage during continuous printing on a printer.

(Making of Support and Formation of Back Layer)

The back layer in accordance with the invention must be formed within three hours after the polyolefin resin layer on the second side of the support is formed. When the back layer is formed within three hours after the polyolefin resin layer is formed, favorable contact characteristics can be obtained without transportation problems such as blocking. The back layer is preferably formed within one hour after the polyolefin resin layer on the second side of the support is formed. More preferably, as described below, the polyolefin resin layer on the second side of the support and the back layer are formed in succession.

The manufacturing process of the support having a subbing layer on the first side and a back layer on the second side (hereinafter sometimes referred to as processed support) is described below with reference to the drawings. Members having the same function are denoted by the same reference numerals throughout the drawings, and repetitive description thereof may sometimes be omitted.

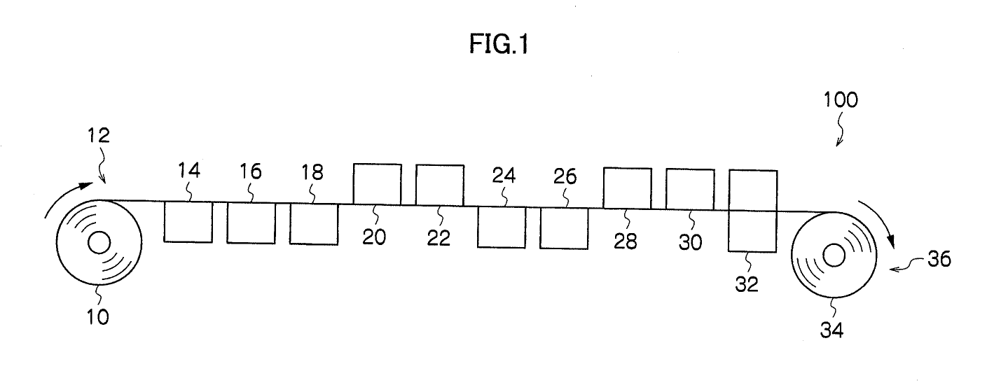

FIG. 1 is an explanatory drawing showing the manufacturing line for manufacturing a support and forming a back layer and a subbing layer in succession in one pass. A feed device 12 loaded with a base paper 10 wound in a roll is installed at the upper end of a manufacturing line 100, and the feed device 12 continuously feeds the base paper 10 downstream. The manufacturing line 100 includes, from the upstream end to the downstream end along the transportation path of the base paper 10, a printer 14, an activator 16, a laminator 18, an activator 20, a laminator 22, an activator 24, a back layer formation device 26, an activator 28, a subbing layer formation device 30, and a dryer 32. The base paper 10 treated with these units is wound by a winder 36 installed at the downstream end of the manufacturing line 100 to give a processed support 34.

The printer 14 prints characters (a logo) representing the name of the product or company on the second side of the base paper 10, as necessary. After the logo or the like is printed by the printer 14, the activator 16 activates the second side of the base paper 10. The activator is a device capable of activation treatment such as corona discharge treatment and flame treatment. Subsequently, the laminator 18, which is capable of extrusion coating by flow-casting a heat-melted polyolefin resin, covers the second side of the base paper 10 with the polyolefin resin to form a polyolefin resin layer.

The first side of the base paper 10 is activated by the activator 20, and then covered with the polyolefin resin by the laminator 22 to form a polyolefin resin layer. Through the above process, the support (resin-coated paper) in accordance with the invention is made.

The surface of the polyolefin resin layer on the second side of the base paper 10 is activated by the activator 24, and then coated with a coating solution for forming a back layer by the back layer formation means 26 to form a back layer. The coating solution for forming a back layer contains a polyurethane resin, a solvent, and as necessary various additives. The back layer formation means 26 may be, for example, a curtain coater, a roll coater, a reverse roll coater, an air knife coater, a blade coater, or a spray coater.

The surface of the polyolefin resin layer on the first side of the base paper 10 is activated by the activator 28, and then coated with a coating solution for forming a subbing layer by the subbing layer formation unit 30 to form a subbing layer. The coating solution for forming a subbing layer contains a water-soluble polymer, a polymer latex, a solvent, and as necessary various additives. The subbing layer formation unit 30 may be, for example, a curtain coater, a roll coater, a reverse roll coater, an air knife coater, a blade coater, or a spray coater.

The base paper 10 through the above process is dried by the dryer 32, and wound in a roll by the winder 36 to give a processed support 34. The processed support made through the manufacturing line 100 has a polyolefin resin layer and a back layer on the second side, wherein the layers are formed in succession.

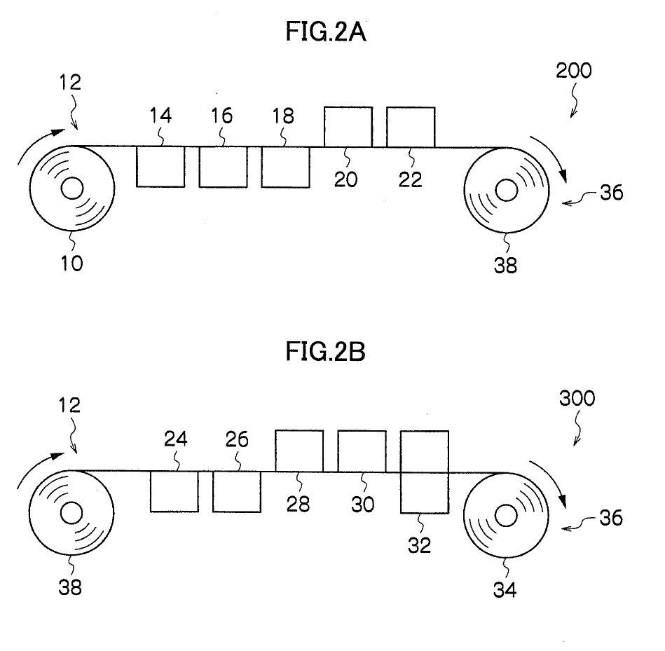

FIG. 2 is an explanatory drawing showing manufacturing lines for manufacturing a support and forming a back layer and a subbing layer separately in two passes. FIG. 2A shows a manufacturing line for manufacturing a support, and FIG. 2B shows another manufacturing line for forming a back layer and a subbing layer.

In a manufacturing line 200, a base paper 10 is fed by a feeder 12, and treated by a printer 14, an activator 16, a laminator 18, an activator 20, and a laminator 22, and then taken up as a support 38 (resin-coated paper) by a winder 36.

The support 38 made by the manufacturing line 200 is fed by a feeder 12 in a manufacturing line 300, and treated by an activator 24, a back layer formation unit 26, an activator 28, a subbing layer formation unit 30, and a dryer 32, and then taken up by a winder 36 to form a processed support 34.

In the processed support made via the manufacturing line 200 and the manufacturing line 300, the polyolefin resin layers are laminated to obtain a support, the support is first taken up and then subjected to treatment for forming a back layer. Therefore, the interval between the formation of the polyolefin resin layer on the second side and the formation of the back layer may be longer than that for a processed support made through the manufacturing line 100. In the invention, making of the support and formation of the back layer and the subbing layer are preferably carried out in succession in one pass.

(Ink Receiving Layer)

The ink jet recording material of the invention has an ink receiving layer on the first side of the support. The layer structure of the ink receiving layer is not particularly limited but preferably includes, from the support side, an ink absorption layer containing inorganic fine particles, polyvinyl alcohol, and a thioether-based compound, and a layer containing colloidal silica. This layer structure can improve the ozone resistance of images printed on the ink jet recording material.

(Ink Absorption Layer)

The ink absorption layer according to the invention preferably contains inorganic fine particles, polyvinyl alcohol, and a thioether-based compound. Specific examples of the inorganic fine particles include fumed silica, colloidal silica, titanium dioxide, barium sulfate, calcium silicate, zeolite, kaolinite, halloysite, mica, talc, calcium carbonate, magnesium carbonate, calcium sulfate, pseudo-boehmite, zinc oxide, zinc hydroxide, alumina, alumina silicate, calcium silicate, magnesium silicate, zirconium oxide, zirconium hydroxide, cerium oxide, lanthanum oxide, and yttrium oxide. Among them, fumed silica is preferable for forming a favorable porous structure.

The content of the fumed silica in the ink absorption layer is preferably about 50% by mass or more, more preferably about 60% by mass or more, and even more preferably from about 65 to about 95% by mass relative to the total solid content in the layer.

Fumed silica is prepared by a flame hydrolysis method. Specifically, under a commonly known method, fumed silica is prepared by burning silicon tetrachloride together with hydrogen and oxygen. Alternatively, silicon tetrachloride may be replaced with silanes such as methyltrichlorosilane, which may be used alone or in combination with silicon tetrachloride. Examples of commercially available fumed silica include AEROSIL series manufactured by Nippon Aerosil Co., Ltd. and QS Type manufactured by K.K. Tokuyama.

The fumed silica used in the invention preferably has an average primary particle diameter of about 30 nm or less, and preferably is dispersed so as to have an average secondary particle diameter of about 400 nm or less. In order to achieve higher ink absorption properties and glossiness, it is preferable that fumed silica having an average primary particle diameter of from about 3 nm to about 20 nm be dispersed so as to have an average secondary particle diameter of from about 30 nm to about 300 nm.

The average primary particle diameter of the fumed silica is determined as follows: the particles are dispersed to an extent that the primary particle diameter can be determined, and the projected areas of 100 particles in a specified area are measured by electron microscopy, and then the diameters of circles equivalent to the projected areas are averaged to determine the average primary particle diameter. The average secondary particle diameter is a value obtained by measuring a dilute dispersion liquid with a laser diffraction/scattering particle size distribution analyzer.

In the invention, the solid coating weight of the ink absorption layer is preferably from about 20 g/m² to about 40 g/m², more preferably from about 22 g/m² to about 30 g/m².

In the invention, the ink absorption layer preferably contains a thioether-based compound to improve storability of the printed areas (with respect to fading caused by trace gases such as ozone and nitrogen oxide in the air). The thioether-based compound used in the invention is preferably a compound expressed by Formula (A).

R₁-(S-R₃)m-S-R₂ Formula (A)

In the formula (A), R₁ and R₂ each independently represent a hydrogen atom, an alkyl group, or an aromatic group, R₁ and R₂ may be the same or different from each other, and may be bonded together to form a ring. At least one of R₁ and R₂ is an alkyl group or an aromatic group substituted with a hydrophilic group such as an amino group, an amide group, an ammonium group, a hydroxyl group, a sulfo group, a carboxyl group, an aminocarbonyl group, or an aminosulfonyl group. R₃ may be substituted, and may be an alkylene group having an oxygen atom. m represents a positive number from 0 to 10. When m is 1 or more, at least one sulfur atom bonded to R₃ may be a sulfonyl group.

Examples of the thioether-based compound include 3-thia-1,5-heptanediol, 4-thia- 1,7-pentanediol, 3,6-dithia- 1,8-octanediol, 3,6,9-rithia- 1,11-undecanediol, 3,9-dithia-6-oxa-1,11-undecanediol, methylenebis(thioglycollic acid), and bis[2-(2-hydroxyethylthio)ethyl]sulfone.

The content of the thioether-based compound in the ink absorption layer is preferably from about 0.5 to about 50% by mass, more preferably from about 1 to about 40% by mass with respect to the total solid content in the layer.

The ink absorption layer preferably contains a hydrophilic binder for high transparency and high ink permeability. When using the hydrophilic binder, the hydrophilic binder must not block voids by swelling during initial penetration of the ink. Considering this, the swelling of the hydrophilic binder is preferably relatively small at temperatures in the vicinity of room temperature. Preferable examples of the hydrophilic binder include completely or partially saponified polyvinyl alcohol or cation-modified polyvinyl alcohol.

Examples of the cation-modified polyvinyl alcohol include polyvinyl alcohols as described in JP-A No. 61-10483, which have a primary to tertiary amino group or a quaternary ammonium group in the main chain or side chain thereof.

Among the polyvinyl alcohols, preferable is a partially saponified polyvinyl alcohol having a degree of saponification of 80% or more, or a completely saponified polyvinyl alcohol. A polyvinyl alcohol having an average polymerization degree of from about 500 to about 5,000 is preferable. For desirable coating properties and ink absorption properties of the ink absorption layer, a polyvinyl alcohol having an average polymerization degree of from 3,000 to 4,000 is preferable.

The ratio of the hydrophilic binder to the fumed silica in the ink absorption layer is preferably from about 10 to about 30% by mass, more preferably from about 12 to about 25% by mass.

The ink absorption layer preferably contains, in addition to the hydrophilic binder, a boron-containing compound as a hardener. Examples of the boron-containing compound include boric acid, a borate, and borax, which may be used alone or in combination of two or more of them. Examples of the borate include orthoborate, metaborate, diborate, tetraborate, and pentaborate.

The ink absorption layer preferably further contains a water-soluble aluminum compound as an ink fixer for improving water resistance of dye inks. The compound is preferably a basic poly aluminum hydroxide compound, such as a water-soluble polyaluminum hydroxide stably containing a basic, polymeric, and polynuclear condensed ion such as [Al₆(OH)₁₅]³⁺, [Al₈(OH)₂₀]⁴⁺, [Al₁₃(OH)₃₄]⁵⁺, and [A₂₁(OH)₆₀]³⁺, and the main component of the compound is expressed by the following formula 1, 2, or 3.

[Al₂(OH)ₙCl₆₋ₙ]ₘ Formula 1

[Al(OH)₃]ₙAlCl₃ Formula 2

Alₙ(OH)ₘCl₍₃ₙ₋ₘ₎ Formula 3, wherein 0<m<3n

Examples of commercially available products thereof include polyaluminum chloride as a water-treating agent (trade name: PAC, manufactured by Taki Chemical Co., Ltd.), polyaluminum hydroxide (trade name: Paho, manufactured by Asada Chemical Industry Co., Ltd.; trade name: PURACHEM WT, manufactured by Riken Green Co., Ltd.). Other products of various grades for similar purposes are available from other manufacturers. In the invention, these commercial products may be used without modification.

The usage of the ink fixer is preferably from about 2% by mass to about 6% by mass, more preferably from about 3% by mass to about 5% by mass with respect to the fumed silica.

In the invention, the ink absorption layer may contain, in addition to the hardener and the ink fixer, known various additives such as a surfactant, an ultraviolet absorber, an antioxidant, a pigment dispersant, an anti-foaming agent, a leveling agent, a preservative, a viscosity stabilizer, and a pH adjusting agent.

The ink jet recording material of the invention preferably has a layer containing colloidal silica (hereinafter sometimes referred to as colloidal silica-containing layer) on the ink absorption layer. The content of the colloidal silica in the colloidal silica-containing layer is preferably about 70% by mass or more, more preferably about 80% by mass or more, and even more preferably about 90% by mass or more with respect to the total solid content in the layer.

The colloidal silica-containing layer is preferably an uppermost layer to further improve glossiness and provide textures that are smooth and pleasant to the touch. In particular, when the solid coating weight of the colloidal silica in the layer is about 0.3 g/m² or less, thereby forming a thin layer, excellent glossiness and pleasing textures can be obtained, while also maintaining high ink absorption properties. In addition, color dullness (glossiness deterioration) in high-density image areas printed with pigment inks can be prevented. The lower limit of the solid coating weight of the colloidal silica is about 0.05 g/m². When the solid coating weight of the colloidal silica is 0.05 g/m² or more, sufficient glossiness and pleasing textures can be obtained. The solid coating weight of the colloidal silica is more preferably from about 0.1 to about 0.25 g/m².

The colloidal silica used in the invention is an aqueous colloidal dispersion of silicon dioxide obtained by double decomposition of sodium silicate with an acid or the like, or heat aging of a silica sol passed through an ion exchange resin layer. The colloidal silica used in the invention preferably has an average primary particle diameter of from about 20 nm to about 80 nm, more preferably from about 20 nm to about 60 nm for glossiness of background areas and desirable ink absorption properties.

Examples of commercially available colloidal silica include PL-10A, PL-3L, and PL-1 manufactured by Fuso Chemical Co., Ltd., and SNOWTEX ST-20, ST-30, ST-40, ST-C, ST-N, ST-20L, ST-O, ST-OL, ST-S, ST-XS, ST-XL, ST-YL, ST-ZL, ST-OZL, ST-UP, ST-OUP, and ST-PS-MO manufactured by Nissan Chemical Industries, Ltd.

The colloidal silica-containing layer may further contain, for example, a hydrophilic binder, a surfactant, and a pH adjusting agent. The content of the hydrophilic binder is preferably about 5% by mass or less with respect to the colloidal silica, and more preferably no hydrophilic binder is added in order to obtain desirable ink absorption properties.

Exemplary aspects of the invention are listed below.

(1) A first aspect of the invention is an ink jet recording material comprising: a support having a base paper and polyolefin resin layers covering the both sides of the base paper; an ink receiving layer formed on one side of the support; and a back layer containing a polyurethane resin formed on the other side of the support opposite to the side having the ink receiving layer, wherein the back layer is formed within three hours after the polyolefin resin layer is formed on the other side of the base paper.

(2) A second aspect of the invention is a method for manufacturing an ink jet recording material, wherein a support having a base paper and polyolefin resin layers covering the both sides of the base paper; an ink receiving layer formed on one side of the support; and a back layer containing a polyurethane resin formed on the other side of the support opposite to the side having the ink receiving layer, are formed, wherein the back layer is formed within three hours after the polyolefin resin layer is formed on the other side of the base paper.

(3) A third aspect of the invention is the method of (2) for manufacturing an ink jet recording material, wherein the polyolefin resin layer and the back layer on the other side of the support are formed in succession.

(4) A fourth aspect of the invention is the ink jet recording material of (1), wherein the ink receiving layer includes, from the support side, an ink absorption layer containing inorganic fine particles, polyvinyl alcohol, and a thioether-based compound, and a layer containing colloidal silica.

(5) A fifth aspect of the invention is the method of (2) for manufacturing an ink jet recording material, wherein the ink receiving layer includes, from the support side, an ink absorption layer containing inorganic fine particles, polyvinyl alcohol, and a thioether-based compound, and a layer containing colloidal silica.

(6) A sixth aspect of the invention is the method of (3) for manufacturing an ink jet recording material, wherein the ink receiving layer includes, from the support side, an ink absorption layer containing inorganic fine particles, polyvinyl alcohol, and a thioether-based compound, and a layer containing colloidal silica.

### EXAMPLES

The ink jet recording material of the invention is further illustrated with reference to, but is not limited to, the following examples.

### Example 1

(Making of Polyolefin Resin-Coated Paper (Support))

A 2:1 mixture of hardwood bleached kraft pulp (LBKP) and hardwood bleached sulfite pulp (LBSP) was beaten to a Canadian freeness of 320 ml thereby preparing a pulp slurry. To the slurry, an alkyl ketene dimer as a sizing agent, polyacrylamide as a strengthening agent, cationized starch, and a polyamide epichlorohydrin resin were added at ratios of 0.6%, 1.2%, 1.2%, and 0.6% respectively, with respect to the pulp, and the mixture was diluted with water to make a 1% slurry. The slurry was processed through a Fourdrinier machine into a sheet having a basis weight of 200 g/m², and the sheet was dried and conditioned to give a base paper to be coated with a polyolefin. Anatase titanium of 10% by mass was uniformly dispersed in a low-density polyethylene resin of 100% by mass to make a polyethylene resin composition, and the composition was melted at a temperature of 315° C., and extruded onto the first side of the base paper at the rate of 200 m/minute with a thickness of 35 μm, and then extrusion coating was carried out using a cooling roll having a micro-rough surface. In the same manner, a blend resin composition composed of 70 parts by mass of a high-density polyethylene resin and 30 parts by mass of a low-density polyethylene resin was melted at a temperature of 315° C., and applied onto the other side (the second side) by extrusion with a thickness of 35 μm, and then extrusion coating was carried out using a cooling roll having a rough surface.

The side of the polyolefin resin-coated paper support on which a back layer is to be formed (the second side of the support) was subjected to high-frequency corona discharge treatment one hour after the polyethylene resin layer was formed on the second side, and then a back layer having the following composition was applied to the side and dried so as to form a solid coating weight of the polyurethane resin of 1.0 g/m². Subsequently, the other side of the support on which the ink absorption layer is to be formed (the first side) was subjected to high-frequency corona discharge treatment, and then a subbing layer having the following composition was applied to the side and dried so as to give a coating amount of gelatin of 50 mg/m² thereby making a processed support. The production of the processed support was carried out by the manufacturing line as shown in FIG. 2.

(Back Layer)

Polyester-based polyurethane resin (glass transition temperature: 60° C., trade name: HW-350, manufactured by Dainippon Ink And Chemicals, Incorporated): 100 parts by mass

Nonionic surfactant (HLB 13.6): 0.3 parts by mass

(Subbing Layer)

Lime-processed gelatin: 100 parts by mass

Sulfosuccinic acid-2-ethylhexyl ester salt: 2 parts by mass

Chromium alum: 10 parts by mass

(Ink Jet Recording Material)

An ink absorption layer having the following composition was applied to the first side (subbing layer side) of the support so as to give a solid coating weight of 25 g/m², then a colloidal silica-containing layer having the following composition was applied thereto to give a solid coating weight of colloidal silica of 0.2 g/m², and dried to form an ink receiving layer, thereby forming an ink jet recording material.

(Ink Absorption Layer)

Fumed silica (trade name: AEROSIL 300SF, manufactured by Nippon Aerosil Co., Ltd.): 100 parts by mass (average primary particle diameter: 7 nm);

Dimethyldiallyl ammonium chloride: 3 parts by mass;

Polyvinyl alcohol (degree of saponification: 88%, average degree of polymerization: 3500): 23 parts by mass;

Thioether-based compound (3,6-dithia-1,8-octanediol): 3 parts by mass;

Basic poly aluminum hydroxide: 3 parts by mass;

Boric acid: 4 parts by mass;

Water was added to give a solids concentration of 10% by mass.

(Colloidal Silica-Containing Layer)

Colloidal silica (trade name: PL-3L, manufactured by Fuso Chemical Co., Ltd.): 100 parts by mass (average primary particle diameter: 32 nm);

Water was added to give a solids concentration of 0.5% by mass.

### Example 2

An ink jet recording material of Example 2 was made in the same manner as Example 1, except that, when making the polyolefin resin-coated paper of Example 1, both sides of the base paper were coated with the polyolefin resin, and then the support was not taken up, but processed on the manufacturing line as shown in FIG. 1, so as to apply and dry a back layer and a subbing layer in the same manner as Example 1, and thus a processed support was prepared. In Example 2, the polyethylene resin layer and the back layer were successively formed on the second side.

### Comparative Example 1

An ink jet recording material of Comparative Example 1 was made in the same manner as Example 1, except that, when making the polyolefin resin-coated paper of Example 1, 15 hours after both sides of the support were coated with the polyolefin resin, a back layer and a subbing layer were applied and dried in the same manner as Example 1 to make a processed support.

### Example 3

An ink jet recording material of Example 3 was made in the same manner as Example 1, except that, when making the ink jet recording material of Example 1, no thioether-based compound (3,6-dithia-1,8-octanediol) was contained in the ink absorption layer.

### Example 4

An ink jet recording material of Example 4 was made in the same manner as Example 1, except that, when making the ink jet recording material of Example 1, no colloidal silica-containing layer was provided.

### Comparative Example 2

An ink jet recording material of Comparative Example 2 was made in the same manner as Example 1, except that, when making the polyolefin resin-coated paper of Example 1, a back layer having the following composition was applied and dried to give a solid coating weight of the polyacrylic resin of 1.0 g/m², to make a processed support.

(Back Layer)

Polyacrylic resin (glass transition temperature: 120° C.): 100 parts by mass

(Image Clarity)

The surface of the ink receiving layer of the above ink jet recording materials was measured with a touch panel type image clarity meter (trade name: ICM-1T, manufactured by Suga Test Instrument Co., Ltd.) to determine the image clarity (C value %) in accordance with JIS-H-8686, at a reflected light angle of 60° and an optical comb width of 2.0 mm. The results are shown in Table 1.

(Evaluation of Ozone Resistance)

An image was printed on each of the ink jet recording materials using an ink jet printer (trade name: PM-A950, manufactured by Seiko Epson Corporation), and stored for two days in an environment having an ozone concentration of 10 ppm. The change in the image before and after storage was evaluated in accordance with visual inspection. The evaluation criteria are as follows: (A) No image change inspected; (B) Slight image change inspected; and (C) Significant image change inspected. The results are shown in Table 1.

(Runnability)

Each of the ink jet recording materials was cut into A4 sized-sheets, and 20 sheets were loaded in the paper feed tray of an ink jet printer (trade name: PM-A950, manufactured by Seiko Epson Corporation), and successively fed in the printer in an environment having a temperature of 10° C. and a relative humidity of 20%. Ten cycles of the operation were carried out to feed 200 sheets, and the incidence of defective paper feeding was evaluated on the basis of the following criteria. The results are shown in Table 1.
A: Incidence of defective paper feeding was 0%.
B: Incidence of defective paper feeding was larger than 0% and less than 1%.
C: Incidence of defective paper feeding was 1% or more and less than 5%.
D: Incidence of defective paper feeding was 5% or more.

(Adhesiveness)

In order to evaluate the adhesiveness of the back layer of the ink jet recording materials, CELLOTAPE (trade name: CT405AP-24, manufactured by Nichiban Co., Ltd.) was adhered to the surface of the back layer, subsequently removed at an angle of 90°, and evaluated by visual observation in accordance with the following criteria. The results are shown in Table 1.
A: No exfoliation occurred.
B: Partial exfoliation occurred at an allowable level.
C: Exfoliation occurred.

(Blocking Properties)

Each of the ink jet recording materials was cut into 10×10 cm pieces, and conditioned for one day in an environment having a temperature of 23° C. and a relative humidity of 80%. Thereafter, five sheets of the ink jet recording material were stacked with the front side (ink receiving layer side) and the back side (back layer side) opposed to each other, and stored for one week under a load of 2 kg in an environment having a temperature of 40° C. and a relative humidity of 80%. After storage, the average level of the blocking properties was evaluated in accordance with the following criteria. The results are shown in Table 1.
A: Released by a small force with no peeling noise.
B: Released with a peeling noise, however no exfoliation or coating breakage occurred.
C: Released accompanied by partial exfoliation or coating breakage.
D: Completely stuck together, and released accompanied by exfoliation or coating breakage.

TABLE 1

| | Back layer | Front/back | Before printing | During printing | After printing |
|---|---|---|---|---|---|
| | | Blocking | Image clarity | | |
| | Adhesiveness | properties | (%) | Runnability | Ozone resistance |
| Example 1 | A | A | 65.8 | A | A |
| Example 2 | A | A | 66.3 | A | A |
| Comparative | B | C | 60.3 | C | B |
| Example 1 | | | | | |
| Example 3 | A | B | 62.1 | B | B |
| Example 4 | A | B | 62.4 | B | B |
| Comparative | C | D | 64.3 | D | A |
| Example 2 | | | | | |

The invention provides an ink jet recording material and a method for manufacturing the same, wherein the ink jet recording material provides an excellent image clarity and runnability in a printer, and the back layer thereof has favorable contact characteristics and blocking properties in high humidity.

All publications, and technical standards mentioned in this specification are herein incorporated by reference to the same extent as if each individual publication, patent application, or technical standard was specifically and individually indicated to be incorporated by reference.

What is claimed is:

1. An ink jet recording material, comprising:
a support having a base paper and polyolefin resin layers covering the both sides of the base paper;
an ink receiving layer formed on one side of the support; and
a back layer containing a polyurethane resin formed on the other side of the support opposite to the side having the ink receiving layer,
wherein the back layer is formed within three hours after the polyolefin resin layer is formed on the other side of the base paper.

2. A method for manufacturing an ink jet recording material, comprising:
forming a support having a base paper and polyolefin resin layers covering the both sides of the base paper;
forming an ink receiving layer on one side of the support; and
forming a back layer containing a polyurethane resin on the other side of the support opposite to the side having the ink receiving layer,
wherein the back layer is formed within three hours after the polyolefin resin layer is formed on the other side of the base paper.

3. The method of claim 2 for manufacturing an ink jet recording material, wherein the polyolefin resin layer and the back layer on the other side of the support are formed in succession.

4. The ink jet recording material of claim 1, wherein the ink receiving layer includes, from the support side, an ink absorption layer containing inorganic fine particles, polyvinyl alcohol, and a thioether-based compound, and a layer containing colloidal silica.

5. The method of claim 2 for manufacturing an ink jet recording material, wherein the ink receiving layer includes, from the support side, an ink absorption layer containing inorganic fine particles, polyvinyl alcohol, and a thioether-based compound, and a layer containing colloidal silica.

6. The method of claim 3 for manufacturing an ink jet recording material, wherein the ink receiving layer includes, from the support side, an ink absorption layer containing inorganic fine particles, polyvinyl alcohol, and a thioether-based compound, and a layer containing colloidal silica.
